(19) United States
(12) Patent Application Publication
(10) Pub. No.: US 2005/0237302 A1
(43) Pub. Date: Oct. 27, 2005

(54) Optical mouse capable of increasing voltage to a predetermined voltage level and measuring movement with respect to a surface

(76) Inventors: Chin-Chou Lee, Hsin-Chu City (TW); Chin-Hsin Yang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/904,298

(22) Filed: Nov. 3, 2004

(30) Foreign Application Priority Data
Apr. 22, 2004 (TW) 093111246

(51) Int. Cl. G09G 5/08

(52) U.S. Cl. 345/166

(57) ABSTRACT

An input device for screen navigation. The input device includes a light source for emitting light onto a surface over which the input device move, a power port for receiving electric power to operate the input device, and an optical module. The input device includes, a voltage regulator formed on a substrate for regulating the voltage of electric power to the desired level, an optical imaging module formed on the substrate for capturing successive images of the surface and producing imaging signals corresponding to the captured images, a motion determining circuit formed on the substrate for producing a motion signal of the input device based on the successive imaging signals, and a modulating circuit formed on the substrate for modulating the motion signal. The input device also includes a RF module for transforming the modulated motion signal into a RF signal to be transmitted to a receiver for screen navigation.

### BACKGROUND OF INVENTION

1. Field of the Invention

The present invention relates to an optical mouse, and more specifically, to an optical mouse having a module capable of increasing voltage to a predetermined voltage level and measuring movement with respect to a surface.

2. Description of the Prior Art

Compared with a traditional mechanical mouse, an optical mouse receives continuous plane images promptly and compares the images with each other to determine the moving direction and distance for an optical mouse. The principle of optical sensing in an optical mouse and the method for dealing with continuous image data are both well known in the prior art, and will not be discussed further here. Because there is no mechanical moving parts which may be abraded or stuck in an optical mouse, an optical mouse is reliable.

Please refer to FIG. 1. FIG. 1 is a bottom view of the optical mouse 10 according to the prior art. As the FIG. 1 shows, there is a flat surface 12, which has a hole 14, on the bottom of the optical mouse 10. The flat surface 12 is made from material with a low attrition factor with the aim of pushing the optical mouse 10 by outside force. The optical mouse 10 emits light with a light-emitting diode (not shown in FIG. 1) to the surface through the hole 14, scans and seizes plane images rapidly, and contrasts the difference between before seizing images and after. The displacement of the optical mouse 10 is counted by an optical sensing chip (not shown in FIG. 1) installed inside the optical mouse 10 as the content of seized images changes, and then the displacement data will be transformed into axial displacement signals and transmitted to a computer (not shown in figures) through a cable line 16 (or transmitted wirelessly) which may have one of several standard adapters, such as a communication port (COM port), PS/2 port, USB, etc. An optical mouse in the prior art counts the moving direction and distance in the optical reflection and produces relative moving signals. No further description is given here, for the principle of optical reflection in an optical mouse is well known among skilled technicians.

For the time being, some manufacturers provide a voltage regulator in an optical mouse with the aim of increasing working voltage to drive the operation of related circuits in an optical mouse without increasing extra batteries. Generally speaking, there are two methods of controlling output voltage for a normal DC/DC voltage regulator, one is PWM (Pulse Width Modulation), and the other is PFM (Pulse Frequency Modulation). Regardless of whether PWM or PFM is used, both of them require an oscillator for the PWM or PFM control circuit to adjust the output voltage, thereby generating the output voltage with various irregular-frequency ripples as the magnitude of load current. As far as the optical sensor which demands higher quality of power source is concerned, the ripple voltage serves as noise, reducing the quality of images, or causing errors in the identification of moving traces. Consequently, integrating an appropriate and cheap voltage regulator into an optical sensor is always the goal of the manufacturer.

In general, a wireless optical mouse not only comprises the above-mentioned voltage regulator and optical sensing chips but also a micro-controller or a hardware circuit of a modulating circuit used for transforming motion signals into RF signals. However, when the wireless optical mouse adopting 27 MHz as a carrier frequency launches high-power signals through the antenna in a radiant manner, the launched signals may radiantly spread to the micro-controller or the optical sensor, resulting in incorrect operation of the micro-controller or incorrect error identification performed by the optical sensor. For this reason, it is necessary to arrange a shield layout or to EMI-proof components or materials on the printed circuit board for preventing EMI from being a problem.

### SUMMARY OF INVENTION

It is therefore an objective of the claimed invention to provide an optical mouse which combines and integrates a voltage regulator and an optical module into one single chip, so that the optical mouse not only increases the input voltage to the working voltage which the optical mouse requires, but also integrates the hardware circuit of the modulating circuit into one single chip so as to take valid measures to solve the problems of diverse signals in power sources or radio-frequency disturbance.

According to the claimed invention, an input device for screen navigation, comprises a light source for emitting light onto a surface over which the input device move, a power port for receiving electric power to operate the input device, an optical module, and a RF module. The optical module comprises a substrate, a voltage regulator, formed on the substrate, for regulating the voltage of electric power to the desired level, an optical imaging module, formed on the substrate, for capturing successive images of the surface and producing imaging signals corresponding to the captured images, a motion determining circuit, formed on the substrate and electrically coupled with the optical imaging module, for producing a motion signal of the input device based on the successive imaging signals, and a modulating circuit, formed on the substrate and electrically coupled with the motion determining circuit, for modulating the motion signal. The RF module is electrically coupled with the modulating circuit and used for transforming the modulated motion signal into a RF signal to be transmitted to a receiver for screen navigation.

According to the claimed invention, an input device for screen navigation comprises a light source for emitting light onto a surface over which the input device move, a power port for receiving electric power to operate the input device, and an optical module. The optical module comprises a substrate, a voltage regulator, formed on the substrate, for regulating the voltage of electric power to the desired level, an optical imaging module, formed on the substrate, for capturing successive images of the surface and producing imaging signals corresponding to the captured images, a motion determining circuit, formed on the substrate and electrically coupled with the optical imaging module, for producing a motion signal of the input device based on the successive imaging signals, a modulating circuit, formed on the substrate and electrically coupled with the motion determining circuit, for modulating the motion signal, and a RF module, formed on the substrate and electrically coupled with the modulating circuit, for transforming the modulated motion signal into a RF signal to be transmitted to a receiver for screen navigation.

According to the claimed invention, an input device for screen navigation, comprises a light source for emitting light onto a surface over which the input device move, a power port for receiving electric power to operate the input device, an optical module, a modulating circuit, and a RF module. The optical module comprises a substrate, a voltage regulator, formed on the substrate, for regulating the voltage of electric power to the desired level, an optical imaging module, formed on the substrate, for capturing successive images of the surface and producing imaging signals corresponding to the captured images, and a motion determining circuit, formed on the substrate and electrically coupled with the optical imaging module, for producing a motion signal of the input device based on the successive imaging signals. The modulating circuit is electrically coupled with the motion determining circuit and used for modulating the motion signal. The RF module is electrically coupled with the modulating circuit and used for transforming the modulated motion signal into a RF signal to be transmitted to a receiver for screen navigation.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a bottom view of the optical mouse of the prior art.

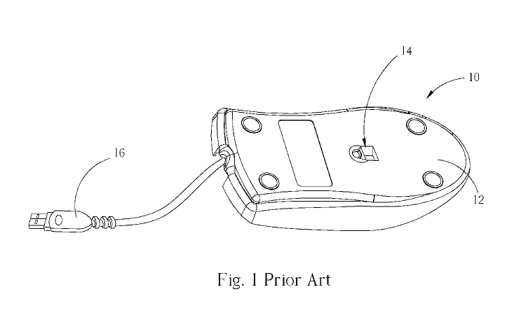

FIG. 2 is an inside component diagram of the optical mouse of the present invention.

FIG. 3 is a perspective drawing of the optical mouse in FIG. 2 positioned on a surface.

FIG. 4 is a functional block diagram of the optical mouse transmitting RF signals to a computer host according to the present invention.

FIG. 5 is a circuit diagram of the voltage regulator in FIG. 4.

FIG. 6 is a timing diagram of inductor voltage V_{L} and capacitor current I_{c} of voltage regulator in FIG. 5.

FIG. 7 shows a second embodiment of the optical module according to the present invention.

FIG. 8 shows a second embodiment of the optical module according to the present invention.

### DETAILED DESCRIPTION

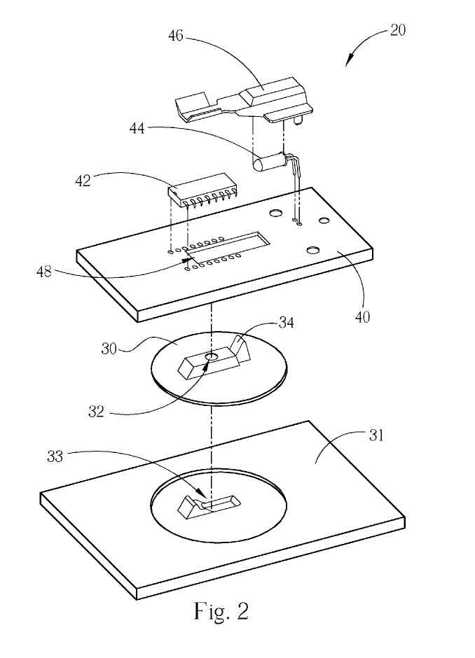

Please refer to FIG. 2 showing an assembly diagram 20 of the optical mouse 10. As shown in FIG. 2, the optical mouse 10 further includes a lens module 30 installed above a hole 33 on a bottom surface 31, a circuit board 40 installed above the lens module 30, an optical module 42 installed above the circuit board 40, a LED 44 (or a laser diode) installed above the circuit board 40, and an optical mask 46 installed above the circuit board 40. The optical module 42 is used for capturing images of the working surface that the optical mouse 10 has passed by to analyze and judge the displacement of the optical mouse 10. The LED 44 is used as a light source of the optical module 42, and the optical mask 46 is used to prevent light from the LED 44 from directly entering into the optical module 42. The lens module 30 includes a lens 32, a first reflection surface 34 and a second reflection surface 36. The circuit board 40 includes an aperture 48 positioned above the lens 32, and the optical module 42 is installed above the aperture 48 of the circuit board 40. The first reflection surface 34 protrudes out of the aperture 48 so that it is located between the LED 44 and the optical module 42.

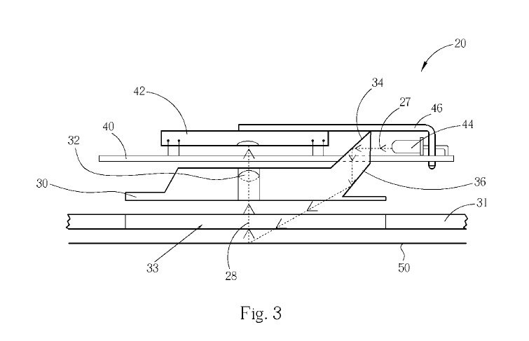

Please refer to FIG. 2 in conjunction with FIG. 3, which shows the optical mouse 20 shown in FIG. 2 positioned on a working surface 50. As shown in FIG. 3, the LED 44 is opposite to the first reflection surface 34 and generates a ray 27. The ray 27 will progress toward the first reflection surface 34 and be reflected downwards by the first reflection surface 34 to the second reflection surface 36. After being reflected by the second reflection surface 36, the ray 27 passes through the hole 33 on the bottom surface 31 and irradiates a working surface 50 under the optical mouse 20. The working surface 50 modulates the characteristics of the ray 27 and reflects the ray 27 to the lens 32 to be a reflected ray 28. The reflected ray 28 will be converged and focused on the optical module 42 by the lens 32, and the optical module 42 determines the movement of the optical mouse 50 according to the change of the reflected ray 28. However, if the working surface 50 is highly transparent or is a special color (e.g. a piece of glass or a glossy surface), the ray 27 incident on the working surface 50 cannot be completely reflected to the optical module 42, so that the optical module 42 cannot receive continuous images of the working surface 50, and the cursor of the optical mouse 20 cannot be in the right place.

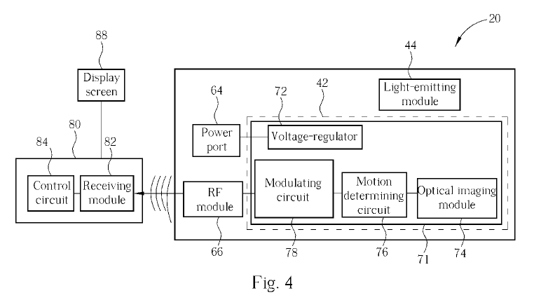

Please refer to FIG. 2 with FIG. 4. FIG. 4 is a functional block diagram in which the optical mouse 20 transmits RF signals to a computer host 80 according to the present invention. The optical mouse 20 also comprises a power port 64 and a RF module 66. The power port 64 is for use in installing batteries to generate an input voltage. The optical module 42 comprises a substrate 71, a DC/DC voltage regulator 72, an optical imaging module 74, a motion determining circuit 76 and a modulating circuit 78. The voltage regulator 72 connects to the power port 64 to increase the input voltage to a working voltage. And the working voltage generated by the voltage regulator 72 will be provided to the optical imaging module 74, the motion determining circuit 76, the modulating circuit 78 and the RF module 66 to drive the operation of the circuits (for clarity, the connection between the voltage regulator 72 and other circuits is not shown in FIG. 4.). Please take notice that the DC/DC voltage regulator 72, the optical imaging module 74, the motion determining circuit 76 and modulating circuit 78 are all formed on the same substrate 71.

While the optical mouse 20 is moving on the surface 50, the light 27 generated by the light-emitting diode 44 is reflected by the surface 50, and then the reflected light 28 enters into the optical imaging module 74. The optical imaging module 74 will generate sensing signals corresponding to emitted light and transmit the sensing signals to the motion determining circuit 76. The motion of the optical mouse 20 causes a change of sensing signal generated by the optical imaging module 74, so that the motion determining circuit 76 electrically connected to the optical imaging module 74 will determine the current motion vector and velocity of the optical mouse 20 according to the changed sensing signals. The modulating circuit 78 connected to the motion determining circuit 76 will transform the motion signals of the motion vector and velocity generated by the motion determining circuit 76 into the wireless signals. Finally, the RF module 66 electrically connected to the modulating circuit 78 will transform the wireless signals generated by the modulating circuit 78 into RF signals and transmit them to a computer host 80. The computer host 80 includes a receiving module 82 and a control circuit 84. The receiving module 82 is used for receiving the RF signals transmitted from the RF module 66, transforming them into a demodulated signal and then transmitting the demodulated signal to the control circuit 84. Finally, the control circuit 84 will determine the motion vector and velocity of the optical mouse 20 based on the transformed demodulated signal. Thus, the computer host 80 can be operated according to the motion vector and velocity of the optical mouse 20. Besides that, the computer host 80 also comprises a display screen 88 for displaying the moving traces of the optical mouse 20 in the display screen 88 according to the motion vector and the velocity of the optical mouse 20 determined by the control circuit 84. The RF module 66 is able to transform the received wireless signals into a RF signal, which is carried by a carrier having frequency of 27 MHz or 2.4 GHz.

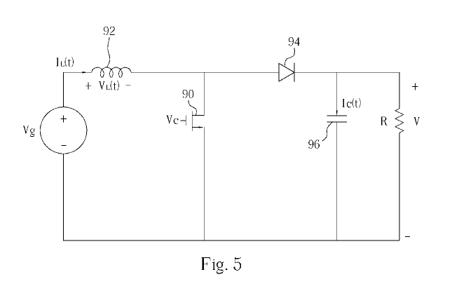

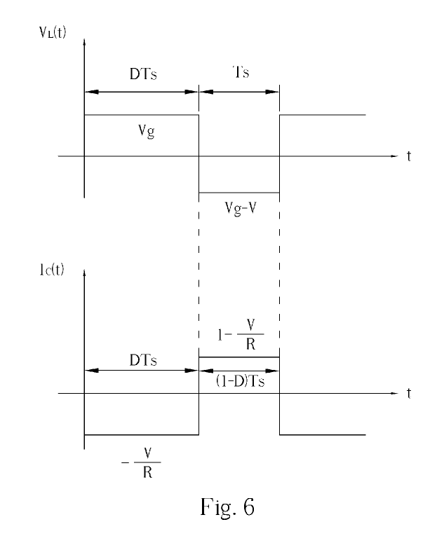

Please refer to the FIG. 5 with reference to FIG. 6. FIG. 5 is a circuit diagram of the voltage regulator 72 in FIG. 4. FIG. 6 is a timing diagram of inductor voltage V_{L} and capacitor current I_{c} of voltage regulator 72 in FIG. 5. In the present embodiment, the voltage regulator 72 is a DC/DC converter, but in fact, any voltage regulators able to raise input voltage are all in the scope of the present invention. A MOS 90 serves as a switch of which the gate is connected to a control voltage Vc. The control voltage is a square wave with a duty circle Ts, and D represents the ratio of the square wave on the period corresponding to positive voltage level to the whole cycle Ts. When a positive voltage level of the control voltage Vc is applied, the MOS 90 turns on, and at this moment, the Vg will charge the inductor 92 and restore energy in the inductor 92. On the other hand, when a zero voltage level of the control voltage Vc is applied, the MOS 90 turns off. At this moment, the voltage across the inductor 92 will reverse due to Lenz law, and the input voltage Vg through the diode 94 results in the output voltage V being higher than the input voltage Vg. FIG. 6 is a timing diagram of inductor voltage VL and capacitor current I_{c} as the control voltage Vc changes. It leads to the following equation from FIG. 6:

$${\int }_{0}^{Ts} {V}_{L} ( t ) = VgDTs + ( Vg - V ) ( 1 - D ) Ts$$

$$VgDTs + ( Vg - V ) ( 1 - D ) Ts = 0$$

$$therefore , V = \frac{Vg}{1 - D}$$

In other words, the magnitude of the voltage V is determined based on the conducting cycle of the control voltage Vc. The voltage level of the input voltage Vg can be raised to a working voltage V according to the conducting cycle D by using the voltage regulator 72. For instance, suppose that the power port 64 is designed to set up a 1.5V battery, but the required working voltage of the circuit in the optical mouse 20 is 3V. The input voltage generated by the power port is 1.5V but the 1.5V input voltage can be increased to a working voltage of 3V by means of the voltage regulator 72. As a result, the circuits in the optical mouse 20 work regularly with only one 1.5V battery.

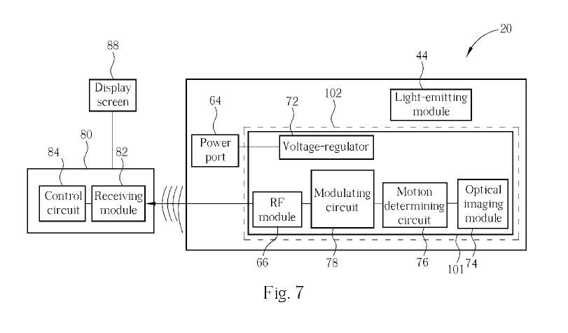

Please refer to FIG. 7, which shows a second embodiment of the optical module according to the present invention. Elements that have the same function as that illustrated in FIG. 4 are provided the same item numbers used in FIG. 7. Differing from the optical module depicted in FIG. 4, the voltage regulator 72, the optical imaging module 74, the motion determining module 76, the modulating module 78 and the RF module 66 are formed on the substrate 101, and packaged as a single chip, i.e. the optical module 102.

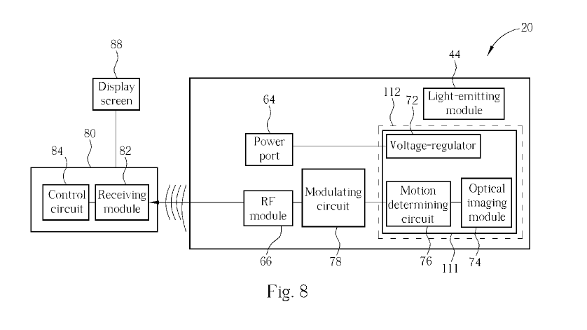

Please refer to FIG. 8, which shows a third embodiment of the optical module according to the present invention. Elements that have the same function as that illustrated in FIG. 4 are provided the same item numbers used in FIG. 8. Differing from the optical module depicted in FIG. 4, the voltage regulator 72, the optical imaging module 74, and the motion determining module 76 are formed on the substrate 111, and packaged as a single chip, i.e. the optical module 112.

In the prior art, the voltage regulator and the modulating circuit exercised are individual chips. However, the present invention optical mouse integrates the voltage regulator and the modulating circuit into one single chip. Consequently, the voltage regulator is able to increase the input voltage generated by the power port appropriately. Besides that, noises of power sources or interference of RF circuits can be improved because both the voltage regulator and the modulating circuit are packaged into a single chip.

Those skilled in the art will readily observe that numerous modifications and alterations of the device may be made while retaining the teachings of the invention. Accordingly, the above disclosure should be construed as limited only by the metes and bounds of the appended claims.

1. An input device for screen navigation, comprising:
a light source for emitting light onto a surface over which the input device move;
a power port for receiving electric power to operate the input device;
an optical module comprising:
a substrate;
a voltage regulator, formed on the substrate, for regulating the voltage of electric power to the desired level;
an optical imaging module, formed on the substrate, for capturing successive images of the surface and producing imaging signals corresponding to the captured images;
a motion determining circuit, formed on the substrate and electrically coupled with the optical imaging module, for producing a motion signal of the input device based on the successive imaging signals; and
a modulating circuit, formed on the substrate and electrically coupled with the motion determining circuit, for modulating the motion signal; and
a RF module, electrically coupled with the modulating circuit, for transforming the modulated motion signal into a RF signal to be transmitted to a receiver for screen navigation.

2. The input device of claim 1, wherein the light source is one of a light-emitting diode and a laser diode.

3. The input device of claim 1, wherein the voltage regulator is a DC/DC converter.

4. The input device of claim 1, wherein the RF signal is carried by a carrier having frequency around 27 MHz.

5. The input device of claim 1, wherein the RF signal is carried by a carrier having frequency around 2.4 GHz.

6. An input device for screen navigation, comprising:
a light source for emitting light onto a surface over which the input device move;
a power port for receiving electric power to operate the input device;
an optical module comprising:
a substrate;
a voltage regulator, formed on the substrate, for regulating the voltage of electric power to the desired level;
an optical imaging module, formed on the substrate, for capturing successive images of the surface and producing imaging signals corresponding to the captured images;
a motion determining circuit, formed on the substrate and electrically coupled with the optical imaging module, for producing a motion signal of the input device based on the successive imaging signals;
a modulating circuit, formed on the substrate and electrically coupled with the motion determining circuit, for modulating the motion signal; and
a RF module, formed on the substrate and electrically coupled with the modulating circuit, for transforming the modulated motion signal into a RF signal to be transmitted to a receiver for screen navigation.

7. The input device of claim 6, wherein the RF signal is carried by a carrier having frequency around 27 MHz.

8. The input device of claim 6, wherein the RF signal is carried by a carrier having frequency around 2.4 GHz.

9. An input device for screen navigation, comprising:
a light source for emitting light onto a surface over which the input device move;
a power port for receiving electric power to operate the input device;
an optical module comprising:
a substrate;
a voltage regulator, formed on the substrate, for regulating the voltage of electric power to the desired level;
an optical imaging module, formed on the substrate, for capturing successive images of the surface and producing imaging signals corresponding to the captured images; and
a motion determining circuit, formed on the substrate and electrically coupled with the optical imaging module, for producing a motion signal of the input device based on the successive imaging signals;
a modulating circuit electrically coupled with the motion determining circuit for modulating the motion signal; and
a RF module electrically coupled with the modulating circuit for transforming the modulated motion signal into a RF signal to be transmitted to a receiver for screen navigation.

10. The input device of claim 9, wherein the modulating circuit is implemented by a micro-controller.

11. The input device of claim 9, wherein the modulating circuit is implement by an ASIC (Application Specific Integrated Circuit).
